(19) United States
(12) Patent Application Publication
(10) Pub. No.: US 2011/0063273 A1
(43) Pub. Date: Mar. 17, 2011

(54) Electrophoresis Display Apparatus and Display Circuit Thereof

(75) Inventors: Ya-Rou Chen, Hsinchu (TW); Heng-Hao Chang, Hsinchu (TW)

(73) Assignee: PRIME VIEW INTERNATIONAL CO., LTD, Hsinchu (TW)

(21) Appl. No.: 12/757,405

(22) Filed: Apr. 9, 2010

(30) Foreign Application Priority Data
Sep. 11, 2009 (TW) 098130680

(51) Int. Cl. G06F 3/038; G09G 3/34

(52) U.S. Cl. 345/211; 345/107

(57) ABSTRACT

An electrophoresis display apparatus has a display circuit and a voltage source. The display circuit comprises a gate line, a common voltage line substantially orthogonal to the gate line, a data line and a display unit. The gate line provides a gate voltage, the common voltage line provides a common voltage, and the data line provides a data voltage. The display unit is coupled to the gate line, the common voltage line and the data line to receive the gate voltage, the common voltage and the data line and works according to the gate voltage, the common voltage and the data line.

This application claims priority to Taiwan Patent Application No. 098130680 filed on Sep. 11, 2009.

### CROSS-REFERENCES TO RELATED APPLICATIONS

Not applicable.

### BACKGROUND OF THE INVENTION

1. Field of the Invention

The present invention relates to an electrophoresis display apparatus and a display circuit thereof. More specifically, the present invention relates to an electrophoresis display apparatus having a common voltage line which is orthogonal to a gate line and the display circuit thereof.

2. Descriptions of the Related Art

Advancement of electronic display technologies has led to wide application of various electronic display apparatuses in people's daily life, and the displaying quality of these display apparatuses are satisfying people's demands to an ever greater extent. As one of these display apparatuses, electrophoresis display apparatuses adopting the electrophoresis display technology combines advantages of the conventional paper and electronic display apparatuses together. That is, the electrophoresis display apparatuses can not only provide superior displaying quality, but also features light weight, a slim profile and good portability just like the conventional paper, so electrophoresis display apparatuses such as electronic books have become more and more popular in recent years.

To illustrate how a conventional electrophoresis display apparatus works, FIG. 1 shows a schematic view of a circuit 1 included in the conventional electrophoresis apparatus. The circuit 1 comprises a data line 11, a gate line 13, a common voltage line 15 and a display unit 17. The data line 11 provides a data voltage 110, the gate line 13 provides a gate voltage 130, the common voltage line 15 provides a common voltage 150, the display unit 17 is coupled to the data line 11, the gate line 13 and the common voltage line 15 for receiving the data voltage 110, the gate voltage 130 and the common voltage 150 thus to work according to the data voltage 110, gate voltage 130 and the common voltage 150.

It can be seen from FIG. 1, since the common voltage line 15 is substantially parallel to the gate line 13 and substantially orthogonal to the data line 11, an electric capacity is generated between the common data line 15 and the data line 11, which would be charged and discharged by the data line 11. The data voltage 110 has a higher frequency than that of the gate voltage 130, so the electric capacity is charged and discharged by the data line 11 at the high frequency as the same as the data voltage 110. Consequently, the display circuit 1 consumes much electric energy during operation, leading to higher power consumption of the conventional electrophoresis display apparatus. Additionally, charging and discharging of the capacitance by the data line 11 also lead to the so-called cross-talk phenomenon, which would cause interference with the display unit 17 and consequently degrade the product yield.

In view of the above, it is highly desirable in the art to improve power consumption for the electrophoresis display device and reduce signal interference between adjacent lines, thereby to improve the product yield.

### SUMMARY OF THE INVENTION

The primarily objective of this invention is to provide a circuit display for use in an electrophoresis display apparatus. The electrophoresis comprises a voltage source which is electrically connected to the display circuit. The voltage source is configured to drive the display circuit. The display circuit comprises a gate line, a data line, a common voltage line and a display unit. The gate line is configured to provide a gate voltage. The common voltage line is substantially orthogonal to the gate line and is configured to provide a common voltage. The data line is configured to provide a data voltage. The display unit is coupled to the gate line, the common voltage line and the data line to receive the gate voltage, the common voltage and the data voltage, and works according to the gate voltage, the common voltage and the data voltage.

Another objective of this invention is to provide an electrophoresis display apparatus. The electrophoresis display apparatus comprises a voltage source and a display circuit. The voltage source, which is electrically connected to the display circuit, is configured to drive the display circuit. The display circuit comprises a gate line, a data line, a common voltage line and a display unit. The gate line is configured to provide a gate voltage to the common voltage line which is substantially orthogonal to the gate line and is configured to provide a common voltage. The data line is configured to provide a data voltage. The display unit is coupled to the gate line, the common voltage line and the data line to receive the gate voltage, the common voltage and the data voltage, and works according to the gate voltage, the common voltage and the data voltage.

To sum up above all descriptions, the electrophoresis display apparatus of the present invention utilizes the circuit design which is orthogonal across by the common voltage line and the gate line of the display circuit to remove the electric capacity between the common voltage line and the data line to mitigate signal interference between adjacent lines, reduce the power consumption of electricity of the display circuit and improve the display quality and the product yield. Therefore, the electrophoresis display apparatus of the present invention can eliminate the shortcomings of the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of the display circuit of the conventional electrophoresis display apparatus;

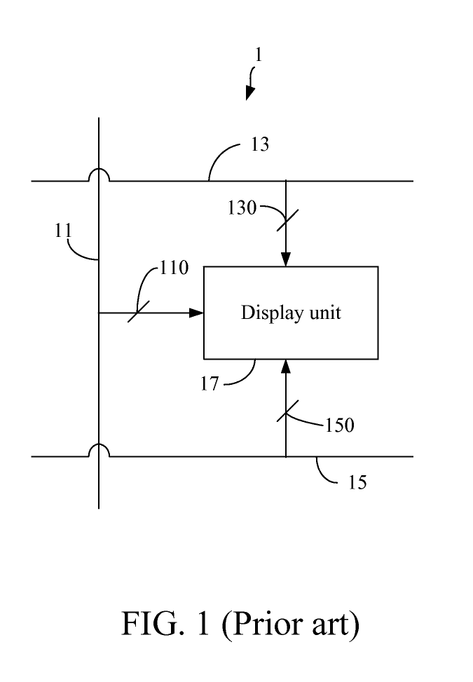

FIG. 2 is a schematic view of an embodiment of the electrophoresis display apparatus of the present invention;

FIG. 3 is a schematic view of an embodiment of the display circuit;

### DESCRIPTION OF THE PREFERRED EMBODIMENT

The present invention provides an electrophoresis display apparatus and a display circuit thereof. In the following descriptions, this invention will be explained with reference to embodiments thereof. However, descriptions of these embodiments are only for illustration rather than limitation. It should be appreciated that in the following embodiments and the attached drawings, elements indirectly related to this invention are omitted from depiction, and dimensional relationships among individual elements depicted in the drawings are only for facilitating the understanding of the invention rather than limiting the actual dimension.

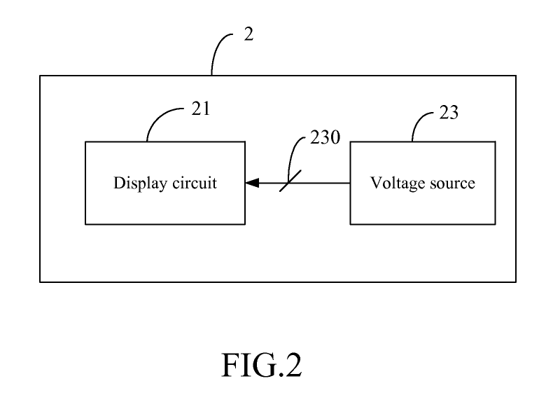

An embodiment of the present invention is illustrated in FIG. 2 which is a schematic view of an electrophoresis display apparatus 2 thereof. The electrophoresis display apparatus 2 comprises a display circuit 21 and a voltage source 23. The voltage source 23 is electrically connected to the display circuit 21 which is configured to provide a working voltage 230 to the display circuit 21 for driving the display circuit 21 so that the display circuit 21 may work normally. Driving the display circuit 21 by the voltage source 23 may be accomplished by a conventional technology, and will not be further described herein.

To describe the display circuit 21 of the present invention in more detail, FIG. 2 shows a schematic view of the display circuit 21. It should be noted that although this embodiment is describe with reference to a single display circuit 21, the electrophoresis display apparatus 2 may comprises a plurality of display circuits 21, and how the electrophoresis display apparatus 2 comprising a plurality of display circuits operates will be readily appreciated by people skilled in this filed, thus will not be further described herein.

The display circuit 21 comprises a data line 31, a gate line 33, a common voltage line 35 and a display unit 37. The common voltage line 35 is substantially orthogonal to the gate line 33. The data line 31 provides a data voltage 310, the gate line 33 provides a gate voltage 330, and the common voltage line 35 provides a common voltage 350. The display unit 37 is coupled to the data line 31, the gate line 35 and the common data line 37 for receiving the gate voltage 330, the common voltage 350 and the data voltage 310. Thus, the display unit 37 works according to the gate voltage 330, common voltage 350 and the data voltage 310. It should be noted that in order to make the display unit 37 working normally, a fixed voltage difference exists between the common voltage 350 and the data voltage 310, which can be one of the DC voltage and the AC voltage in practical application.

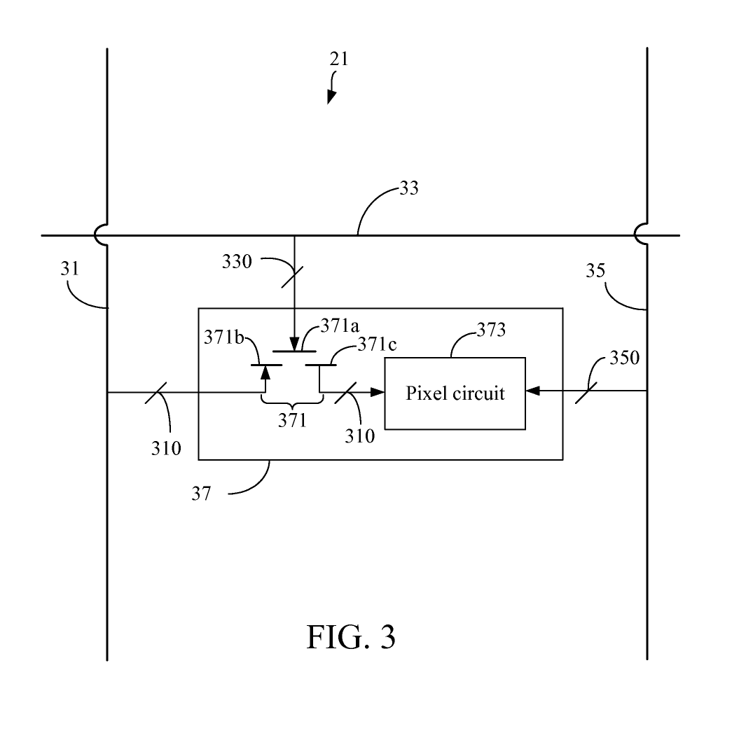

In more detail, referring next to FIG. 3, the display unit 37 comprises a switch circuit and a pixel circuit 373. In this embodiment, the switch circuit may be a thin-film transistor 371, however, in other embodiments, the switch circuit may be other circuits or electronic elements which have switch function. The thin-film transistor 371 is coupled to the data line 31 and the gate line 33 for receiving the data voltage 310 and the gate voltage 330. The thin-film transistor 371 is further coupled to the pixel circuit 373. When the thin-film transistor 371 is turned on according to gate voltage 330, it transfers data voltage 310 to the pixel circuit 373. The pixel circuit 373 is coupled to the common voltage line 35 and is configured to receive the common voltage 350. Thus, the pixel circuit 373 works with the common voltage 350 according to the data voltage 310 when the data voltage 310 is transferred to the pixel circuit 373.

More specifically, the thin-film transistor 371 comprises a gate 371a, a source 371b and a drain 371c. As shown in FIG. 3, the gate 371a is electrically connected to the gate line 33 to receive the gate voltage 330, and the source voltage 371b are electrically connected to the data line 31 to receive the data voltage 310. The drain 371c is electrically connected to the pixel circuit 373. The thin-film transistor 371 is turned on or off according to the gate voltage 330 received by the gate 371a. The data voltage 310 may be transferred from the source 371b to the pixel circuit 373 through the drain 371c so that the pixel circuit 373 works according to the data voltage 310 and the common voltage 350.

To sum up above all descriptions, the electrophoresis display apparatus of the present invention utilizes the circuit design in which the common voltage line is orthogonal to the gate line of the display circuit to remove the electric capacity between the common voltage line and the data line to mitigate signal interference between adjacent lines, reduce the power consumption of the display circuit and improve the display quality and the product yield. Therefore, the electrophoresis display apparatus of the present invention can eliminate the shortcoming of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display circuit for use in an electrophoresis display apparatus, the electrophoresis display apparatus comprising a voltage source electrically connected to the display circuit, the voltage source being configured to drive the display circuit, the display circuit comprising:
a gate line, being configured to provide a gate voltage;
a common voltage line, being substantially orthogonal to the gate line and configured to provide a common voltage;
a data line, being configured to provide a data voltage; and
a display unit, being coupled to the gate line, the common voltage line and the data line, being configured to receive the gate voltage, the common voltage and the data voltage, and to work according to the gate voltage, the common voltage and the data voltage.

2. The display circuit as claimed in claim 1, wherein the display unit comprises:
a switch circuit, being coupled to the gate line and the data line to receive the gate voltage and the data voltage; and
a pixel circuit, being coupled to the common voltage line to receive the common voltage;
wherein the switch circuit is further coupled to the pixel circuit and is turned on according to the gate voltage to transfer the data voltage to the pixel circuit so that the pixel circuit works according to the common voltage and the data voltage.

3. The display circuit as claimed in claim 2, wherein the switch circuit is a thin-film transistor comprising:
a gate, being electrically connected to the gate line to receive the gate voltage;
a source, being electrically connected to the data line to receive the data voltage; and
a drain, being electrically connected to the pixel circuit;
wherein the thin-film transistor is turned on according to the gate voltage to transfer the data voltage to the pixel circuit via the drain so that the pixel circuit works according to the data voltage and the common voltage.

4. The display circuit as claimed in claim 3, wherein a fixed voltage difference exists between the common voltage and the data voltage.

5. The display circuit as claimed in claim 4, wherein the common voltage is one of a DC voltage and an AC voltage.

6. An electrophoresis display apparatus, comprising:
a display circuit; and
a voltage source, being electrically connected to the display circuit to drive the display circuit;
wherein the display circuit comprises:
a gate line, being configured to provide a gate voltage;
a common voltage line, being substantially orthogonal to the gate line and configured to provide a common voltage;
a data line, being configured to provide a data voltage; and
a display unit, being coupled to the gate line, the common voltage line and the data line, being configured to receive the gate voltage, the common voltage and the data voltage, and to work according to the gate voltage, the common voltage and the data voltage.

7. The electrophoresis display apparatus as claimed in claim 6, wherein the display unit further comprises:
a switch circuit, being coupled to the gate line and the data line to receive the gate voltage and the data voltage; and
a pixel circuit, being coupled to the common voltage line to receive the common voltage;
wherein the switch circuit is further coupled to the pixel circuit and is turned on according to the gate voltage to transfer the data voltage to the pixel circuit so that the pixel circuit works according to the data voltage and the common voltage.

8. The electrophoresis display apparatus as claimed in claim 7, wherein the switch circuit is a thin-film transistor comprising:
a gate, being electrically connected to the gate line to receive the gate voltage;
a source, being electrically connected to the data line to receive the data voltage; and
a drain, being electrically connected to the pixel circuit;
wherein the thin-film transistor is turned on according to the gate voltage to transfer the data voltage to the pixel circuit via the drain so that the pixel circuit works according to the data voltage and the common voltage.

9. The electrophoresis display apparatus as claimed in claim 8, wherein a fixed voltage difference exists between the common voltage and the data voltage.

10. The electrophoresis display apparatus as claimed in claim 9, wherein the common voltage is one of a DC voltage and an AC voltage.
